(19) United States
(12) Patent Application Publication
(10) Pub. No.: US 2019/0313313 A1
(43) Pub. Date: Oct. 10, 2019

(54) METHOD AND DEVICE FOR ROAMING OF WIRELESS NETWORK DEVICE

(71) Applicant: INTERDIGITAL CE PATENT HOLDINGS, PARIS (FR)

(72) Inventor: Min ZHENG, BEIJING (CN)

(21) Appl. No.: 16/470,211

(22) PCT Filed: Dec. 15, 2016
(86) PCT No.: PCT/CN2016/110056

§ 371 Date: Jun. 15, 2019

(51) Int. Cl. H04W 36/24; H04W 36/08

(52) U.S. Cl. CPC H04W 36/24; H04W 84/12; H04W 36/08

(57) ABSTRACT

A method for handing over a wireless network device connecting to a first access point with a first frequency band includes presenting a user interface allowing selection of a preferred frequency band. The method determining to hand-over the wireless network device to a second access point which is configured with the same SSID, security settings, and a second frequency band which is different from the first frequency band when the second frequency band is the same as the preferred frequency band and signal strength of the second frequency band exceeds signal strength of the first frequency band by a threshold value.

### TECHNICAL FIELD

The disclosure generally relates to network technology, and more particularly, to a method and a device for roaming of wireless network device.

### BACKGROUND

WiFi is a local wireless computer networking technology that allows a WiFi network device to connect to the wireless network, mainly using the 2.4 GHz UHF (Ultra High Frequency) or the 5 GHz SHF (Super High Frequency) frequency bands. All the access points in a wireless network can be configured with the same SSID (Service Set Identifier) and security settings to form an “extended service set”. In this case, a WiFi network device can roam (hand-over) from one access point (AP) to another.

FIG. 1 is flowchart illustrating a conventional roaming process for a WiFi network device. As shown in FIG. 1, at step S101, a WiFi scan is performed to provide available APs with respective frequency bands. At step S103, the scan results is retrieved/updated, for example, according to the signal strength level on respective frequency bands. At step S105, a frequency band is selected for the WiFi network device to connect to an AP/BSS (Basic Service Set). It can be appreciated that a BSS typically corresponds to an access point in infrastructure mode.

At step S107, it is determined whether a difference between the signal strength of the selected AP/BSS and that of the current AP/BSS is equal to or greater than a predefined threshold (for example, in unit dbm). If the result of the step S107 is “Yes”, at step S109, a roaming is carried out by the WiFi network device, by which the WiFi network device will request an association with a selected AP/BSS. If the result of the step S107 is “No”, which means there is no need for the WiFi network device to roam to the selected AP/BSS, at step S111, the wireless network device will maintain the connection to the current AP/BSS.

At present, most WiFi network devices are working in 2.4 GHz frequency band. One reason why many WiFi network devices prefer 2.4 GHz frequency band is that a signal of 2.4 GHz frequency band has better distance propagation than that of a 5 GHz frequency band. With more and more usage of 2.4 GHz WiFi network devices, 2.4 GHz frequency band can get crowded. More seriously, lots of other devices, such as microwave devices and Bluetooth peripherals, are occupying the same frequency band, which can cause a burst of noise around 2.4 GHz spectrum and severely interfere with the wireless signal. In such context, the conventional roaming strategy described with reference to FIG. 1 may have a problem.

According to the above conventional roaming strategy, a network device will connect to the AP/BSS with the frequency band that can provide the strongest signal strength. But since most WiFi network devices are working in 2.4 GHz frequency band, this frequency band can become over occupied. Under such situation, one possible situation that might happen is, the WiFi network device connects to 2.4 GHz AP first, then roams to 5 GHz AP later due to weaker 2.4 GHz signal, and then returns to 2.4 GHz AP later when the signal strength becomes stronger again. That can severely impact the user experience in some cases.

### SUMMARY

According to an aspect of the disclosure, a method is provided for handing over a wireless network device connecting to a first access point with a first frequency band. The method includes presenting a user interface for a user to select a preferred frequency band, and determining to hand over the wireless network device to a second access point which is configured with the same SSID, security settings, a second frequency band which is different from the first frequency band when the second frequency band is the same as the preferred frequency band, and a determination that the signal strength of the second frequency band exceeds signal strength of the first frequency band by a threshold value.

According to another aspect of the disclosure, a wireless network device is provided for handing over from a first access point with a first frequency band to which it connects. The network device includes a processor that is used to present a user interface for a user to select a preferred frequency band. The processor hands-over the wireless network device to a second access point which is configured with the same SSID, security settings, a second frequency band which is different from the first frequency band when the second frequency band is the same as the preferred frequency band, and a signal strength of the second frequency band exceeds signal strength of the first frequency band by a threshold value.

### BRIEF DESCRIPTION OF THE DRAWINGS

The above and other objects, features and advantages will be more apparent from the following description of embodiments with reference to the figures, in which:

FIG. 1 is flowchart illustrating a conventional roaming process for a WiFi network device;

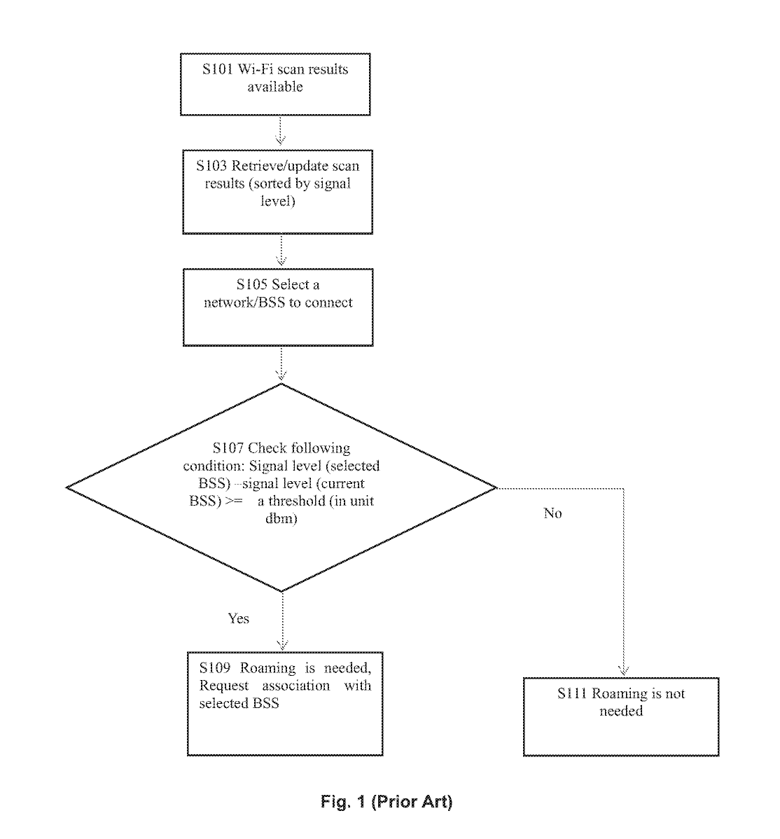

FIG. 2 is a schematic diagram showing a Wi-Fi setting submenu for roaming settings of a user interface of a wireless network device according to an embodiment of the disclosure;

FIG. 3 is flowchart illustrating a roaming process for a dual-band wireless network device according to an embodiment of the disclosure; and

FIG. 4 is a block diagram illustrating a wireless network device according to an embodiment of the disclosure.

### DETAILED DESCRIPTION

The embodiments of the disclosure will be described below with reference to the drawings. It should be noted that the following embodiments are illustrative only, rather than limiting the scope of the disclosure. Detailed description of any well-known steps, devices, components and the like is omitted here to avoid obscuring of the disclosure.

An embodiment of the present disclosure provides a roaming method for a dual band wireless network device that has two selectable working wireless frequency bands. The user of the wireless network device can be provided with a user interface to select a preferred frequency band. Based on the comparison between the current frequency band used by the wireless network device connecting to an access point and the preferred frequency band and also in combination with a signal strength based roaming strategy, it is determined whether the wireless network device is to roam to another access point with another frequency band. Using aspects of the disclosure, the user can get better experience in different use cases and the wireless network device is more flexible against various network environment.

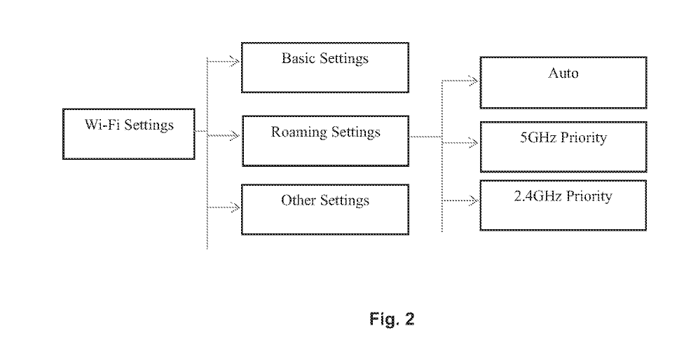

FIG. 2 is a schematic diagram showing a WiFi setting submenu for roaming settings of a user interface of a wireless network device according to an embodiment of the disclosure.

The wireless network device is a dual-band network device which can work in a frequency band of 2.4 GHz to connect to a first access point and a frequency band of 5 GHz to connect to a second access point. The first and the second access points are configured with the same SSID (Service Set Identifier, which consists of 32 octets that frequently contains a human readable identifier uniquely identifying a network) and security settings to form an “extended service set” so that the wireless network device can roam between the two access points according to predefined roaming strategy.

As shown in FIG. 2, a submenu is provided on the wireless network device for the Wi-Fi settings (Graphic user interface is not shown), which comprise basic settings, roaming settings and other settings. In the basic settings, the user can switch on/off WiFi functionality, and only being in the ON state, the wireless network device scans and lists the APs. In the other settings, WPS (Wi-Fi Protected Setup) functionality may be implemented (if the feature is supported by the product) in the user interface to handle rapid and secure WiFi connection.

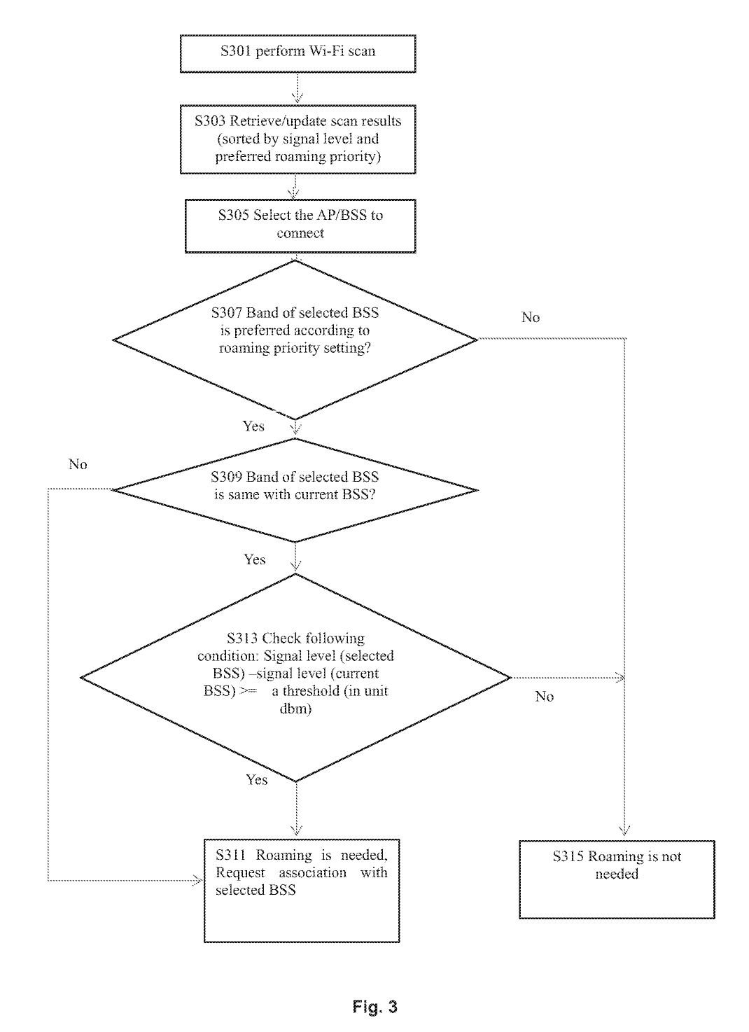

The user can set the roaming strategy as “Auto”, wherein the roaming can be decided according to the signal strength of the two frequency bands. For example, the roaming strategy described in the FIG. 3 can be applied.

The user interface for the roaming settings can also allow the user to select a preferred frequency band. As shown in FIG. 2, the 5 GHz frequency band can be selected as preferred frequency band, in which case this frequency band will have priority for the roaming of the wireless network device. This means that when selecting the BSS (Basic Service Set) to connect, the wireless network device will prefer the AP which is working in 5 GHz frequency band, even another access point working in 2.4 GHz frequency band and having higher signal level is also available in the network. Similarly, the 2.4 GHz frequency band can be selected as preferred frequency band, in which case this frequency band will have priority for the roaming of the wireless network device. This means that when selecting the BSS (Basic Service Set) to connect, the wireless network device will prefer the AP which is working in 2.4 GHz frequency band, even if another access point working in 5 GHz frequency band and having higher signal level is also available in the network.

FIG. 3 is flowchart illustrating a roaming process for a dual-band wireless network device according to an embodiment of the disclosure.

As shown in FIG. 3, at step S301, a WiFi scan is performed to provide available APs with respective frequency bands. At step S303, the scan results is retrieved/updated, and the results can be sorted according to the signal strength level on respective frequency bands in the scan results. By sort, it means the results are listed in an order from the strongest to the weakest. Herein, the signal strength information can be provided by Wi-Fi low level firmware during the Wi-Fi scan. At step S305, an access point/BSS is selected for the wireless network device to connect. It can be appreciated that a BSS (Basic Service Set) typically corresponds to an access point in infrastructure mode.

A submenu of a user interface such as the one shown in FIG. 2 is provided for the user to select a preferred frequency band for the wireless network device to connect to an access point/BSS.

At step S307, it is determined whether the frequency band of the selected access point/BSS is the preferred frequency band in the WiFi settings. If the result of the step S315 is “No”, no roaming is needed.

If the result of the step S307 is “Yes”, the process goes to step S309. At step S309, it is determined whether the current frequency band for the wireless network device to connect to the current access point/BSS is the same as the preferred frequency band.

If the result of the step S309 is “No”, which means that the current frequency band is different from the preferred frequency band, at step S311, the wireless network device roams to another access point/BSS with another frequency band.

If the result of the step S309 is “Yes”, at step S313, it will determine whether a difference between the signal strength of the frequency band of the selected access point/BSS and that of the frequency band of the current access point/BSS is equal to or greater than a threshold.

If the result of the step S313 is “Yes”, at step S311, the wireless network device roams to another access point/BSS with another frequency band. If the result of the step S313 is “No”, which means there is no need for the wireless network device to roam to the selected BSS, at step S315, the wireless network device will maintain the connection to the current AP/BSS.

According to a variant of the embodiment, the step 309 is performed by comparing the band of the current BSS to the preferred band in the WiFi settings. Note that the determination result is the same as before. It is because the positive result of the step S307, which is the previous step of the step S309, indicates the band of the current BSS is the same as the preferred band. According to another variant, the step S309 is removed. That is, the device does not compare the band of the current BSS to either the band of the selected BSS or the preferred band.

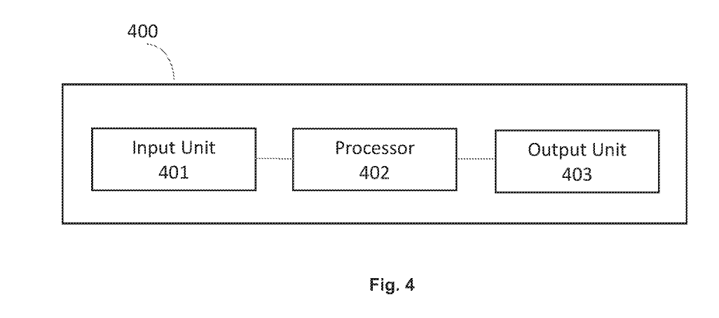

FIG. 4 is a block diagram illustrating a wireless network device according to an embodiment of the disclosure. As shown in FIG. 4, the wireless network device 400 includes an input unit 401, a processor 402, and an output unit 403. The input unit 401 is configured to receive messages from other wireless network devices, such as an access point devices. In an example, the input unit 401 can include a communication port capable of receiving data wirelessly according to the WiFi standard. The output unit 403 is configured to output messages to other devices on a wireless network, such as an access point device. In an example, the output unit 403 can include a communication port capable of transmitting data wirelessly according to the WiFi standard. In this case, the wireless network device can be embodied as a dual-band WiFi network device using the 2.4 GHz UHF (Ultra High Frequency) or the 5 GHz SHF (Super High Frequency) frequency bands. The processor 402 is configured to implement the roaming process in the flow described above with reference to the FIG. 3 to determine whether to roam from a first access point with a first frequency band to a second access point with a second frequency band.

The present disclosure may be implemented by a computer program product, for example, in the form of a computer-readable medium carrying computer program codes structured in computer program modules. The computer program modules, when executed in a processor, cause the image capturing device or the image processing apparatus to perform the actions described above in conjunction with the figures mentioned above. Alternatively, at least one of the codec means may be implemented at least partly as hardware circuits.

The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. For example, the computer program product may be resident in a flash memory, a Random-access memory (RAM), a Read-Only Memory (ROM), or an EEPROM, and the computer program modules described above could in alternative embodiments be distributed on different computer program products in the form of memory devices.

The disclosure has been described above with reference to embodiments thereof. It should be understood that various modifications, alternations and additions can be made by those skilled in the art without departing from the scope of the disclosure. Therefore, the scope of the disclosure is not limited to the above particular embodiments but only defined by the claims as attached.

1. A method comprising:
connecting a wireless network device to a first access point with a first frequency band;
obtaining a preferred frequency band; and
handing over the wireless network device to a second access point configured with the same Service Set Identifier, SSID, and a second frequency band which is different from the first frequency band in case the second frequency band is the same as the preferred frequency band, and a signal strength of the second frequency band exceeds signal strength of the first frequency band.

2. The method according to claim 1, further comprising:
performing a hand-over to the second access point with the second frequency band in case the second frequency band is the same as the preferred frequency band, and the first frequency band is different from the preferred frequency band.

3. The method according to claim 1, further comprising maintaining the connection to the first access point with the first frequency band in case the second frequency band is the same as the preferred frequency band and the signal strength of the second frequency band doesn't exceed signal strength of the first frequency band by a value.

4. The method according to claim 3, wherein the first frequency band is one of either the 2.4 GHz or the 5 GHz frequency bands, and the second frequency band is the other one of the 2.4 GHz and the 5 GHz frequency bands.

5. A wireless network device comprising:
a processor that is configured to:
connect to a first access point with a first frequency band;
obtain a preferred frequency band; and
hand-over the wireless network device to a second access point which is configured with the same SSID, a second frequency band which is different from the first frequency band, in case the second frequency band is the same as the preferred frequency band, and a signal strength of the second frequency band exceeds signal strength of the first frequency band.

6. The device according to claim 5, wherein the processor is further configured to hand-over to the second access point with the second frequency band in case the second frequency band is the same as the preferred frequency band and the first frequency band is different from the preferred frequency band.

7. The device according to claim 5, wherein the processor is further configured to keep the connection to the first access point with the first frequency band in case the second frequency band is the same as the preferred frequency band and signal strength of the second frequency band doesn't exceed signal strength of the first frequency band by a value.

8. The device according to claim 5, wherein the first frequency band is one of either the 2.4 GHz or the 5 GHz frequency band, and the second frequency band is the other one of the 2.4 GHz and the 5 GHz frequency bands.

9. (canceled)

10. Non-transitory computer readable storage medium storing program code instructions executable by a processor for implementing a method according to claim 1.
